(19) United States
(12) Patent Application Publication
(10) Pub. No.: US 2026/0001407 A1
(43) Pub. Date: Jan. 1, 2026

(54) Method for Operating a Drive of an Electric Bicycle, Having a Process of Ascertaining an Overheating Protection of the Electric Drive

(71) Applicant: Robert Bosch GmbH, Stuttgart (DE)

(72) Inventors: Daniel Baumgaertner, Neustetten (DE); Timo Benzel, Tuebingen-Derendingen (DE)

(21) Appl. No.: 18/880,645

(22) PCT Filed: Jun. 30, 2023
(86) PCT No.: PCT/EP2023/067994

§ 371 Date: Jan. 2, 2025

(30) Foreign Application Priority Data
Jul. 6, 2022 (DE) 10 2022 206 896.3
Jun. 16, 2023 (DE) 10 2023 205 655.0

(51) Int. Cl. B60L 3/00; B62M 6/50

(52) U.S. Cl. CPC B60L 3/0061; B62M 6/50; B60L 2240/425; B60L 2240/54; B60L 2240/662

(57) ABSTRACT

A method for operating a drive of an electric bicycle with a determination of an overheating protection of an electric drive is disclosed. The method includes (i) receiving and/or reading status data, wherein the status data comprises a temperature of the electric drive and a temperature gradient of the electric drive, (ii) receiving an overheating protection map and/or reading the overheating protection map from a memory, wherein the overheating protection map indicates a permissible maximum power of the electric drive as a function of the status data, (iii) determining a permissible maximum power from the overheating protection map by way of the status data, and (iv) outputting a power which is at most the permissible maximum power of the electric drive.

The present invention relates to a method for operating a drive of an electric bicycle with a determination of an overheating protection of an electric drive of the electric bicycle, as well as an electric bicycle.

### PRIOR ART

The sales success of an electric bicycle depends, among other things, on the interaction between the behavior of the electric motor and the rider of the electric bicycle. When the rider is propelling the electric bicycle, the electric motor provides assistance and supplies a torque that assists the rider in propelling the electric bicycle. Avoid critical temperatures when operating the electric motor. If the critical temperatures are exceeded, damage will occur to the electric motor, which can lead to failure of the electric motor, a reduction in the service life of the electric motor, or fire in the electric motor. Therefore, reaching such a critical temperature must be avoided at all costs.

To protect the electric motor, maps are stored in the control unit of the electric motor which switch off the electric motor from a switch-off temperature that is lower than the critical temperature. However, the driver of the electric bicycle would not find an abrupt shutdown of the electric motor, without prior notice or warning, to be a pleasant experience. Current control maps for controlling the electric motors take this into account by limiting the power of the electric motor from a temperature that is lower than the cut-off temperature. This way, the control of the electric motor suggests to the driver that the cut-off temperature and the corresponding drop in performance of the electric motor can be expected if the temperature rises further. This enables the driver to reduce the power required by the electric motor in good time and to avoid a drop in assistance due to the electric motor overheating.

### DISCLOSURE OF THE INVENTION

The method according to the invention for operating a drive of an electric bicycle with a determination of an overheating protection of an electric drive with the features of claim 1 comprises several steps. A step includes receiving and/or reading status data, wherein the status data includes a temperature of the electric drive and a temperature gradient of the electric drive. By receiving and/or retrieving the temperature gradient of the electric drive, a time rate of change of the temperature of the electric drive can also be taken into account in addition to the actual temperature of the electric drive.

A further step comprises receiving an overheating protection map and/or reading out the overheating protection map from a memory, wherein the overheating protection map indicates a permissible maximum power of the electric drive as a function of the status data. The permissible maximum power protects the electric drive of the electric bicycle from possible damage due to overheating. This enables lower maintenance, a longer service life and higher performance over the service life of the electric drive.

A further step of the method according to the invention comprises determining a permissible maximum power from the overheating protection map by means of the status data. Accordingly, a permissible maximum power is determined at least by means of the temperature and the temperature gradient of the electric drive. By taking the temperature gradient into account, it is possible to predict the rate of temperature increase of the electric drive at the same temperature and to determine a restriction of the maximum power that can be delivered by the electric drive from the overheating protection map.

In a further step, the electric drive outputs a power that is at most the maximum permissible power of the electric drive. Accordingly, the electric drive can be operated at the same temperature, but with different temperature gradients, with a different permissible maximum power.

The dependent claims show preferred refinements of the invention.

Preferably, the permissible maximum power in the overheating protection map decreases with increasing temperature and/or increasing temperature gradient of the electric drive. The decreasing maximum permissible power output of the electric drive suggests to the driver that the electric drive is at a high temperature and that the electric drive is likely to switch off to protect against overheating.

In the overheating protection map, the permissible maximum power preferably drops from a start temperature and above. This means that at an electric drive temperature greater than or equal to a start temperature, the maximum permissible power of the electric drive is less than the maximum permissible power of the electric drive. From an end temperature, the permissible maximum power no longer drops in the overheating protection map, wherein the end temperature is greater than the start temperature. By setting a start temperature, the drop in the permissible maximum power is limited to the temperature range above the start temperature and above. The driver is therefore not subject to any restrictions on the permissible maximum power of the electric drive in a temperature range below the start temperature. The limited temperature range between the start temperature and the end temperature is sufficient to suggest to the driver in good time that the permissible maximum power of the electric drive has to be restricted due to the high temperatures.

In the overheating protection map, the permissible maximum power is given priority over the final temperature and above it, assuming a value of zero. This means that the electric drive is switched off at and above the end temperature. This prevents the electric drive from reaching a damaging temperature range.

In the overheating protection map, the start temperature with increasing temperature gradients decreases and the start temperature with decreasing temperature gradients increases. At the same temperature and different temperature gradients, a higher temperature is reached in the same time in the case of the higher temperature gradient than in the case of a lower temperature gradient. If, in both cases, the permissible maximum power is restricted from the same start temperature, a higher temperature will be reached in a shorter time and a corresponding restriction of the permissible maximum power will be carried out in the case of a higher temperature gradient. However, at the same temperature, but with different temperature gradients, the driver perceives the restriction of the permissible maximum power as more abrupt at a higher temperature gradient than at a lower temperature gradient. If the start temperature for the restriction of the permissible maximum power at a higher temperature gradient is already at lower temperatures than is the case at lower temperature gradients, the restriction of the permissible maximum power is distributed over a larger temperature range and thus over a longer period. Taking into account the higher temperature gradient, the driver perceives such a reduction in the permissible maximum power of the electric drive as comparable to the reduction at a lower temperature gradient and a higher start temperature.

In a particularly favorable case, the start temperatures are selected as a function of the temperature gradients in such a way that, given a constant temperature gradient, the restriction of the permissible maximum power occurs over the same duration until the end temperature is reached. As a result, the user does not perceive any difference in the restriction of the permissible maximum power at different temperature gradients.

Preferably, the start temperature lies between a first start temperature limit and a second start temperature limit in the overheating protection map, wherein the first start temperature limit is unequal to the second start temperature limit. If a restriction occurs as a result of a very high temperature gradient even at very low temperatures, the driver perceives this as a negative impact. Above a certain temperature gradient, the driver assumes a shorter duration until the final temperature is reached at a constant temperature gradient. In addition, such very high temperature gradients are caused by the driver for short acceleration, as is the case when overtaking. Drivers find the premature restriction of maximum power output at low temperatures to be particularly inconvenient during such overtaking maneuvers. In addition, if the temperature gradient is very low, the temperature range between the start temperature and the end temperature should not be too small. The driver would find this uncomfortable, because at temperatures close to the end temperature, the driver is not yet restricted and therefore does not get an approximation of the end temperature. A change in the temperature gradient in the high temperature range would cause the driver to feel an abrupt reduction in the permissible maximum power of the electric drive, without this having been suggested to him beforehand by a reduction in the maximum electrical power of the electric drive. To take these two circumstances into account, the start temperature is limited to a temperature range between the first start temperature limit value and the second start temperature limit value.

The status data preferably includes the battery charge state of an electrical energy store of the electric bicycle. This makes it possible to make the permissible maximum power in the overheating protection map dependent not only on the temperature and the temperature gradient, but also on the battery charge level. Thus, the overheating protection map can show a higher start temperature for a high battery charge state than for a low battery charge state. In addition, the permissible start temperature can decrease as the battery charge level decreases. This allows the electric drive to deliver unrestricted maximum power until the higher start temperature is reached when an electric energy store is charged. In addition, lowering the start temperature when the battery charge state of the electrical energy storage device is low helps to prevent the electrical energy storage device from reaching a critical state.

Preferably, the status data includes an incline of the path on which the electric bicycle is located and/or a GPS position of the electric bicycle. This makes it possible to make the permissible maximum power in the overheating protection map dependent not only on the temperature and the temperature gradient, but also on the gradient of the path on which the electric bicycle is located. Thus, the overheating protection map may show a higher start temperature for a small increase in distance than for a larger increase in distance. In addition, the permissible start temperature can decrease as the slope of the path decreases. This allows unrestricted maximum power to be drawn from the electric drive for a section of the route without inclines until the higher start temperature is reached. In addition, lowering the start temperature with increasing slope of the path avoids a critical state of the electrical energy storage device.

The status data preferably includes weather information, in particular an ambient temperature. The ambient temperature can be used to take into account a possible cooling effect of the motor by convection and to take into account a possible change over time in the temperature and temperature gradient. Taking the ambient temperature into account makes it possible to make the permissible maximum power dependent not only on the temperature and the temperature gradient, but also on the ambient temperature in the overheating protection map. Thus, the overheating protection map at a high ambient temperature may show a lower start temperature than at a lower ambient temperature. In addition, the permissible start temperature can decrease as the ambient temperature decreases. This allows the unrestricted permissible maximum power to be drawn from the electric drive at a lower ambient temperature until the higher start temperature is reached. In addition, lowering the start temperature at a higher ambient temperature avoids a critical state of the electrical energy storage device.

Furthermore, the invention includes an electric bicycle. The electric bicycle includes sensors, an electrical energy storage device, an electric drive and a control unit. The sensors are designed to measure at least one temperature of the electric drive and one temperature gradient of the electric drive. The control unit is connected to the sensors and the electric drive to exchange data. The control unit is set up to perform a method according to one of the previous embodiments. This enables the control unit to control the electric drive of the electric bicycle depending on the temperature and the temperature gradient.

### BRIEF DESCRIPTION OF THE DRAWINGS

Embodiment examples of the invention are explained in detail below with reference to the accompanying drawings. The drawing shows:

FIG. 1 shows a schematic representation of an electric bicycle according to one exemplary embodiment of the invention, and

FIG. 2 shows a schematic representation of an overheating protection map according to one of the exemplary embodiments of the invention.

### EMBODIMENTS OF THE INVENTION

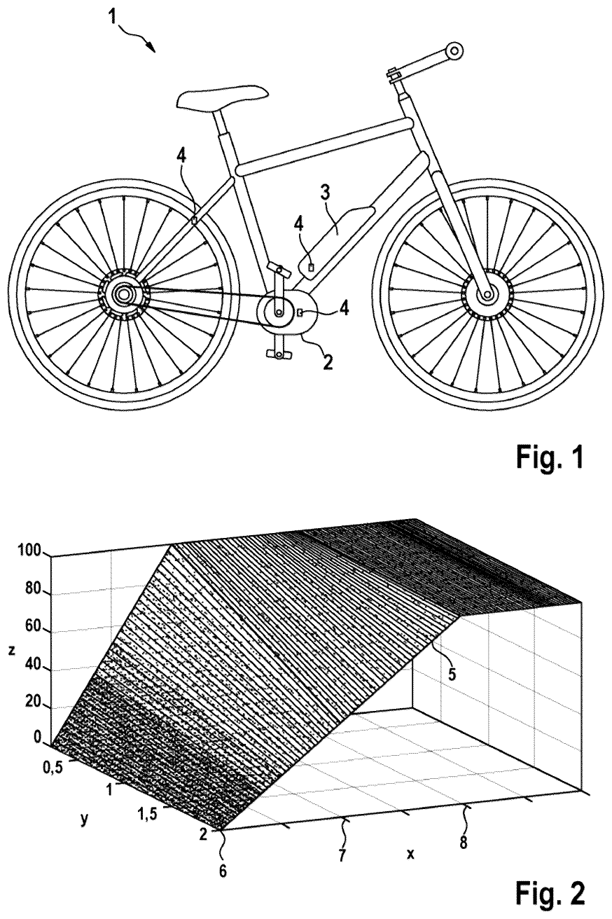

FIG. 1 shows a schematic representation of an electric bicycle 1 according to one exemplary embodiment of the invention. The electric bicycle 1 includes an electrical energy storage device 3, an electric drive 2, sensors 4 and a control unit. The electric drive 2 includes an electric motor. The sensors 4 are set up to measure at least a temperature of the electric drive 2 and a temperature gradient of the electric drive 2. Thus, not only the current temperature of electric drive 2 but also the time rate of change of the temperature of electric drive 2 can be taken into account.

The control unit is connected to at least sensors 4 and electric drive 2 to exchange data. Thus, the four measured variables, such as the temperature of the electric drive 2 and the temperature gradient of the electric drive 2, can be transmitted to the control unit by the sensors 4 and/or retrieved by the control unit from the sensors 4. In addition, the control unit is able to transmit signals to electric drive 2 and thereby control the electric drive 2.

The sensors 4 are preferably set up to detect a battery charge state of the electrical energy storage device 3. The sensors 4 can be set up to determine a slope of the path on which the electric bicycle 1 is located. The sensors 4 are designed to determine the ambient temperature of the electric bicycle 1. The control unit is designed to receive and/or retrieve a GPS position of the electric bicycle 1. Particularly preferably, the control unit is designed to receive and/or retrieve weather information on the location of the electric bicycle 1. Thus, in addition to the temperature and the temperature gradient, the control unit can take into account other important variables for the behavior and change of the thermal load on the electric drive 2 when controlling the electric drive 2.

The electrical energy store 3 and the electric drive 2 are connected to each other via an electrical connection, so that electrical energy can be exchanged between the electrical energy store 3 and the electric drive 2.

The control unit is preferably set up to carry out a method according to one of the previous embodiments. The control unit can receive and/or access the temperature measured by the sensors 4 and the temperature gradient of the electric drive 2 and can receive and/or read a map of overheating protection characteristics 5 from a memory. The control unit is set up to determine a permissible maximum power of the electric drive 2 by means of the overheating protection map 5, the temperature of the electric drive 2 and the temperature gradient, and to transmit this permissible maximum power to the electric drive 2. The temperature gradient allows for a time-based rate of change of temperature of the electric drive 2 when determining the permissible maximum power.

The control unit is particularly designed to receive both the variables measured by the sensors 4, as listed above, and additional weather information at the location of the electric bicycle 1 and a GPS position of the electric bicycle. The control unit is set up to receive and/or read overheating protection map 5 from the memory. The control unit is preferably set up to determine a permissible maximum power of the electric drive 2 by means of the overheating protection map and the variables previously received from the sensors and/or interpreted and the GPS position of the electric bicycle 1 and the weather information at the location of the electric bicycle 1. The control unit sends the maximum permissible power to the electric drive 2. This means that other factors that influence the temperature development of the electric drive 2 can be taken into account.

FIG. 2 shows a schematic representation of an overheating protection map 5. The Z-axis of the overheating protection map 5 indicates the permissible maximum power of the electric drive 2 as a percentage of a maximum permissible maximum power. The Z-axis is listed in the range from 0 to 100 percent of the maximum permissible power. The X-axis of the overheating protection map 5 represents the temperature scale, wherein the temperature scale indicates the temperature of the electric drive 2. End temperature 6 is listed at the left end of the X-axis. Temperatures to the right of end temperature 6 on the X-axis decrease from end temperature 6. Furthermore, a first start temperature 7 and a second start temperature 8 are listed on the X-axis, wherein the second start temperature 8 is lower than the first start temperature 7. The Y-axis of the overheating protection map 5 describes the temperature gradient.

The overheating protection map 5 shows no reduction in maximum permissible maximum power for a constant temperature gradient at temperatures below the associated start temperature 7, 8 for a constant temperature gradient. When the start temperature 7, 8 for a constant temperature gradient is exceeded, the permissible maximum power decreases with increasing temperature. If the temperature reaches the final temperature 6 at a constant temperature gradient, a value of zero is assigned to the maximum permissible power. The electric drive 2 is switched off at a permissible maximum value of zero. This structure of the overheating protection map 5 allows the driver to access the maximum permissible maximum power of the electric drive 2 below a start temperature 7, 8. In addition, the permissible maximum power decreases when the start temperature 7, 8 is exceeded, suggesting to the driver that the electric drive 2 is approaching the final temperature 6 and the associated shutdown of the electric drive 2 before reaching the final temperature 6.

In overheating map 5, the permissible maximum power decreases at a constant rate with a steady temperature gradient up to end temperature 6. In an alternative exemplary embodiment, the course of the permissible maximum power between the start temperature 7, 8 and the end temperature 6 can be arbitrary. The permissible maximum power can be increased in a linear fashion, a concave curve, a convex curve, a logarithmic curve or a staircase function. In one embodiment, the course of the permissible maximum power at a constant temperature gradient between the associated start temperature 7, 8 and the associated end temperature 6 can change depending on the temperature gradient.

In a further exemplary embodiment, the same start temperatures 7, 8 are assigned to the negative temperature gradients in overheating protection map 5 as are assigned to the positive temperature gradients with the same amount of negative temperature gradients. Negative temperature gradients occur when the electric drive 2 cools and reduces the temperature of the electric drive 2. The overheating map also covers the case where the temperature of the electric drive 2 has previously exceeded the end temperature and, after the electric drive has been switched off, the temperature of the electric drive falls and drops below the end temperature. In an alternative exemplary embodiment, in the overheating protection map 5, different start temperatures 7, 8 are assigned to the negative temperature gradients compared to the start temperatures 7, 8 of the positive temperature gradients with the same values of the negative temperature gradients. In a further exemplary embodiment, the same curves are assigned to the negative temperature gradients in the overheating protection map 5 between the end temperature 6 and the associated start temperatures 7, 8, as are assigned to the positive temperature gradients with the same amounts of the negative temperature gradients. In an alternative exemplary embodiment, the negative temperature gradients in the overheating protection map 5 are assigned different curves of the permissible maximum power between the end temperature 6 and the associated start temperatures 7, 8 compared to the curves of the permissible maximum power between the end temperature 6 and the associated start temperatures 7, 8 of the positive temperature gradients with the same amounts of the negative temperature gradients. In an alternative exemplary embodiment, in overheating protection map 5 in the area of negative temperature gradients, the start temperatures 7, 8 correspond to the end temperature 6, so that when the temperature falls below the end temperature 6 at negative temperature gradients, the permissible maximum power corresponds to the maximum permissible maximum power. In a further exemplary embodiment of the overheating protection map 5, the negative temperature gradients are assigned different end temperatures 6 than the positive temperature gradients with the same amounts of the negative temperature gradients.

The overheating protection map 5 shows different start temperatures 7, 8 for different temperature gradients. Preferably, the overheating protection map 5 has the highest start temperature 7 when there is no temperature gradient. The start temperature 7, 8 decreases with increasing temperature gradient. At a constant higher temperature gradient, the temperature changes over time in a shorter period of time than at a lower temperature gradient. If the same start temperature 7, 8 were to be provided for each temperature gradient in overheating protection map 5, the duration between the start temperature 7, 8 and reaching the end temperature 6 would be significantly shorter for a consistently higher temperature gradient than for a consistently lower temperature gradient. The driver perceives such a reduction in the duration between the start temperature 7, 8 and the final temperature 6 as unpleasant if the temperature gradient remains constant. Reducing the start temperature 7, 8 at a higher temperature gradient towards a lower temperature compensates for the effect just described and improves the driver's perception. In a preferred embodiment, the start temperature 7, 8 is adapted to the temperature gradient such that a duration between the start temperature 7, 8 and reaching the final temperature 6 is identical for each temperature gradient at a constant temperature gradient.

The overheating protection map 5 shows the same end temperature for different temperature gradients. In an alternative exemplary embodiment, the end temperature 6 can vary depending on the temperature gradient. This allows for a certain amount of inertia when heating the electric drive 2 and heating the point at which the temperature of the electric drive 2 is measured. In an alternative embodiment, the final temperature 6 decreases with increasing temperature gradient.

In one exemplary embodiment, the overheating protection map comprises five further axes on which the battery charge level and/or the incline of the path on which the electric bicycle 1 is located and/or the ambient temperature of the environment of the electric bicycle 1 are plotted. In this case, the start temperature 7, 8 decreases with increasing ambient temperature and/or increasing incline of the path on which the electric bicycle is located and/or with increasing ambient temperature. This makes it possible to take into account other factors influencing the temperature of the electric drive 2 and their change over time.

1. A method of operating a drive of an electric bicycle with a determination of an overheating protection of the electric drive, comprising:
receiving and/or reading status data, wherein the status data comprises a temperature of the electric drive and a temperature gradient of the electric drive;
receiving an overheating protection map and/or reading out the overheating protection map from a memory, wherein the overheating protection map indicates a permissible maximum power of the electric drive as a function of the status data;
determining a permissible maximum power from the overheating protection map using the status data, and
outputting a power that does not exceed the maximum permissible power of the electric drive.

2. The method according to claim 1, wherein in the overheating protection map the permissible maximum power decreases with increasing temperature and/or increasing temperature gradient of the electric drive.

3. The method according to claim 1, wherein in the overheating protection map the permissible maximum power drops from a start temperature and above and does not drop any further from an end temperature, and wherein the end temperature is greater than the start temperature.

4. The method according to claim 3, wherein in the overheating protection map the permissible maximum power assumes the value zero from the end temperature and above.

5. The method according to claim 3, wherein in the overheating protection map the start temperature decreases with increasing temperature gradients and the start temperature increases with decreasing temperature gradients.

6. The method according to claim 3, wherein in the overheating protection map the start temperature lies between a first start temperature limit value and a second start temperature limit value, and wherein the first start temperature limit value is not equal to the second start temperature limit value.

7. The method according to claim 1, wherein the status data includes a battery charge state of an electrical energy store of the drive of the electric bicycle.

8. The method according to claim 1, wherein the status data includes an incline of the path on which the electric bicycle is located and/or a GPS position of the electric bicycle.

9. The method according to claim 1, wherein the status data includes weather information.

10. A drive system for an electric bicycle comprising:
a control unit, wherein the control unit is set up to carry out a method according to claim 1.

11. An electric bicycle with the drive system according to claim 10.

12. The method according to claim 1, wherein the status data includes an ambient temperature.
